(19) United States
(12) Patent Application Publication
(10) Pub. No.: US 2026/0368644 A1
(43) Pub. Date: Nov. 19, 2026

(54) RESOLVING HALLUCINATIONS WITH AUTONOMOUS DECISION MAKING OF MACHINE LEARNING MODELS

(71) Applicant: NEC Laboratories America, Inc., Princeton, NJ (US)

(72) Inventors: Christopher Malon, Tokyo (JP); Renqiang Min, Princeton, NJ (US); Kai Zhang, Bethlehem, PA (US)

(21) Appl. No.: 19/675,756

(22) Filed: May 13, 2026

Related U.S. Application Data
(60) Provisional application No. 63/806,109, filed on May 15, 2025.
(60) Provisional application No. 63/850,100, filed on Jul. 24, 2025.

(51) Int. Cl. G06N 20/00

(52) U.S. Cl. CPC G06N 20/00

(57) ABSTRACT

Systems and methods for resolving hallucinations with autonomous decision making of machine learning models. Original samples of responses of a machine learning model (MLM) that generates a text description of an image can be processed based on editing heuristics that compares the original samples to reference responses to obtain injected samples. The machine learning model (MLM) can be fine-tuned with original samples and the injected samples. The MLM can be trained with reinforcement learning and group relative policy optimization to avoid hallucinations by utilizing an unnormalized advantage of the original samples and the injected samples to obtain a trained MLM for performing downstream tasks.

### RELATED APPLICATION INFORMATION

This application claims priority to U.S. Provisional App. No. 63/806,109, filed on May 15, 2025, and to U.S. Provisional App. No. 63/850,100, filed on Jul. 24, 2025, incorporated herein by reference in their entirety.

### BACKGROUND

### Technical Field

The present invention relates to optimizing artificial intelligence (AI) decision making, and more particularly to resolving hallucinations with autonomous decision making of machine learning models.

### Description of the Related Art

Artificial intelligence (AI) has been utilized in a broad range of fields. For example, in graphic designing, AI can be used to generate images that can augment artwork. Additionally, in the education space, AI can be used to generate summaries of obscure or complex terminology or concepts.

### SUMMARY

According to an aspect of the present invention, a method is provided, including, processing original samples of responses of a machine learning model (MLM) that generates a text description of an image based on editing heuristics that compares the original samples to reference responses to obtain injected samples, fine-tuning the machine learning model (MLM) with original samples and the injected samples from a text description of an image, and training the MLM with reinforcement learning and group relative policy optimization to avoid hallucinations by utilizing an unnormalized advantage of the original samples and the injected samples to obtain a trained MLM for performing downstream tasks.

According to another aspect of the present invention, a system is provided, including, a memory device, one or more processor devices operatively coupled with the memory device to perform operations, including, processing original samples of responses of a machine learning model (MLM) that generates a text description of an image based on editing heuristics that compares the original samples to reference responses to obtain injected samples, fine-tuning the machine learning model (MLM) with original samples and the injected samples from a text description of an image, and training the MLM with reinforcement learning and group relative policy optimization to avoid hallucinations by utilizing an unnormalized advantage of the original samples and the injected samples to obtain a trained MLM for performing downstream tasks.

According to yet another aspect of the present invention, a non-transitory computer program product is provided including a computer-readable storage medium including a program code, wherein the program code when executed on a computer causes the computer to perform operations including processing original samples of responses of a machine learning model (MLM) that generates a text description of an image based on editing heuristics that compares the original samples to reference responses to obtain injected samples, fine-tuning the machine learning model (MLM) with original samples and the injected samples from a text description of an image, and training the MLM with reinforcement learning and group relative policy optimization to avoid hallucinations by utilizing an unnormalized advantage of the original samples and the injected samples to obtain a trained MLM for performing downstream tasks.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram that shows a system for resolving hallucinations with autonomous decision making of machine learning models, in accordance with an embodiment of the present invention;

FIG. 2 is a block diagram that shows a computer system for resolving hallucinations with autonomous decision making of machine learning models, in accordance with an embodiment of the present invention; and

FIG. 3 is a block diagram that shows components of a computer system for resolving hallucinations with autonomous decision making of machine learning models, in accordance with an embodiment of the present invention;

FIG. 4 is a block diagram that shows subcomponents of a computer system for resolving hallucinations with autonomous decision making of machine learning models, in accordance with an embodiment of the present invention;

FIG. 5 is a flow diagram that shows a high-level overview of resolving hallucinations with autonomous decision making of machine learning models, in accordance with an embodiment of the present invention; and

FIG. 6 is a block diagram that shows an example of a practical application of resolving hallucinations with autonomous decision making of machine learning models, in accordance with an embodiment of the present invention.

### DETAILED DESCRIPTION OF PREFERRED EMBODIMENTS

In accordance with embodiments of the present invention, systems and methods are provided for resolving hallucinations with autonomous decision making of machine learning models

In the present embodiments, original samples of responses of a machine learning model (MLM) that generates a text description of an image can be processed based on editing heuristics that compares the original samples to reference responses to obtain injected samples. The machine learning model (MLM) can be fine-tuned with original samples and the injected samples. The MLM can be trained with reinforcement learning and group relative policy optimization to avoid hallucinations by utilizing an unnormalized advantage of the original samples and the injected samples to obtain a trained MLM for performing downstream tasks.

Automatic generation of chest X-ray reports from medical images represents a significant challenge in multi-modal artificial intelligence. Effective AI systems in this domain can substantially reduce labor costs and help standardize radiological interpretations. Recent multi-modal large language models (MLMs) have achieved competitive performance on natural language generation metrics. However, human evaluations indicate that these models often hallucinate details or omit critical clinical information.

To overcome this drawback, Group Relative Policy Optimization (GRPO) was introduced, which avoids a value function by computing advantages based on normalized rewards relative to peer samples. However, GRPO, as an on-policy RL method, inherently depends on the model's current capabilities, limiting effective skill expansion. This constraint leads to low-quality outputs, frequently defaulting to generic “no finding” statements. Consequently, advantage estimates remain flat, and training performance quickly plateaus.

To address this, the present embodiments utilize EditGRPO, a variant of GRPO that edits generated report candidates during rollout by injecting clinically correct information from reference reports. Edits include deleting or replacing incorrect (false-positive) findings and adding missing (false-negative) findings. These edits keep the model close to its existing policy while enabling off-policy guidance to bring its generations closer to the reference report.

By doing so, the present embodiments allow the training to explore higher reward alternatives that might not be explored if GRPO considered a group of only samples from the current policy. Additionally, because only one sentence is replaced and not the whole report, the injected samples are close to the current policy and allow flexibility of expression. Moreover, corrections involving misdiagnoses and hallucinations are prioritized over including missing diagnoses. Further, flexibility in expression may be allowed by comparing the embeddings of named entities rather than considering exact matches of strings.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

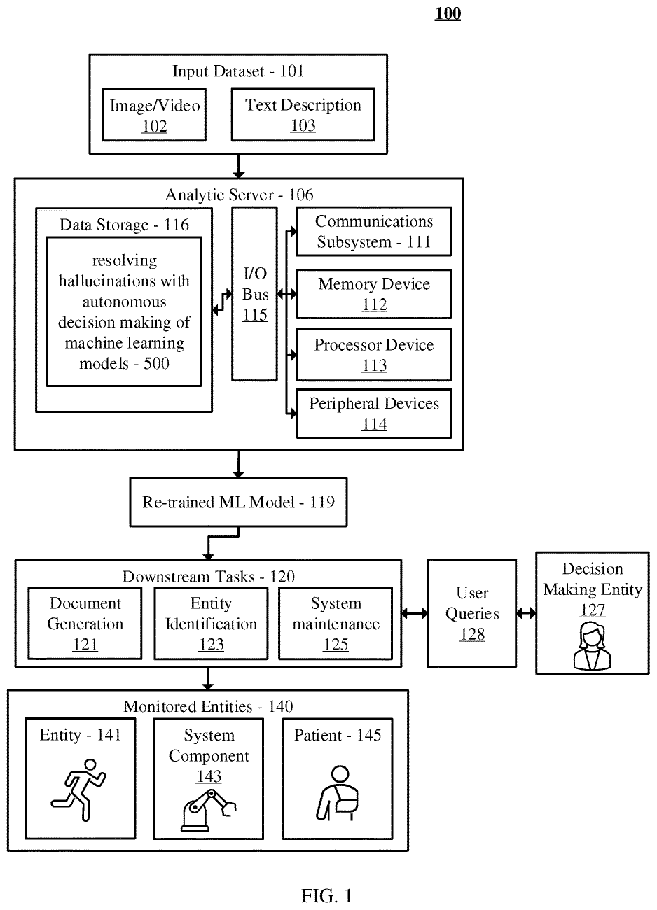

Referring now in detail to the figures in which like numerals represent the same or similar elements and initially to FIG. 1, a block diagram shows a system for resolving hallucinations with autonomous decision making of machine learning models, in accordance with an embodiment of the present invention.

In an embodiment using a system 100, monitored entities 140 can include entity 141, system component 143, and patient 145. The monitored entities 140 can generate an input dataset 101 that includes image/video 102 and text description 103. The image/video 102 and text description 103 can be transmitted to an analytic server 106 that can implement resolving hallucinations with autonomous decision making of machine learning models 500. The analytic server 106 can learn an updated policy from the input dataset 101 with processed fine-grained details that can be utilized to train a machine learning model and obtain a re-trained machine learning model 119. The re-trained machine learning model 119 can be utilized to perform downstream tasks 120.

System 100 can be utilized to perform downstream tasks 120 based on the input dataset 101 and user queries 128 from a decision-making entity 127. The downstream tasks 120 can include document generation 121, entity identification 123, and system maintenance 125. The analytic server 106 can generate a corrective action for the downstream tasks 120 to be sent to respective computing systems for the monitored entities 140 through a network.

In document generation 121, the input dataset 101 can be related to a monitored tissue or body part of a patient 145 such as lungs, heart, intestines, etc. The re-trained machine learning model 119 can generate documents that describe the monitored tissue or body part such as reports describing the status of the monitored tissue with autonomous decision making. For example, the input dataset 101 can include x-ray images and text descriptions of the x-ray. The re-trained machine learning model 119 can determine that the text descriptions have false negatives (e.g., stating that the patient has pneumothorax despite having normal lungs) and has generated processed sentences for the false negatives.

In entity identification 123, the input dataset 101 of the entity 141 can include image/video 102 and text descriptions 103 of monitored tissues or body parts of a patient 145. The predictions of the re-trained machine learning model 119 can identify whether there are anomalies (e.g., abscesses, tumors, malignant cells, etc.) with the monitored tissues or body parts. Based on the predictions, the re-trained machine learning model 119 can generate recommendations to a decision-making entity 127 (e.g., healthcare professional, patient, etc.) such as changing diet, increasing exercise, updating medication, etc.

In another embodiment, the input dataset 101 (e.g., location images, scene images, entity images such as parts of the entity, and text descriptions etc.) related to the entity 141 (e.g., person, vehicle, building, etc.) can be processed by the analysis server 106 to answer user queries 128. The user queries 128 can be relevant to the text descriptions 103 about the entity 141 such as their attributes (e.g., position, direction of movement, color of clothing, etc.), relationship with other entities within a scene (e.g., proximity, behavior, etc.), relationship with the environment, etc. The re-trained machine learning model 119 can predict future attributes, and relationships of the entity 141 based on the learned context of the entities.

Based on the predictions of the re-trained machine learning model 119, a corrective action can be generated. The corrective action can include notifying the decision making entity 127 of the predictions about the entity 141 based on their input dataset 101, correcting the text descriptions 103 about the entity 141 and generating resolutions to an issue caused by the entity (e.g., the entity 141 as a disabled vehicle in a traffic scene and the resolution is the deployment of a repair technician, etc.) of the input dataset 101 to help with the decision making process of the decision making entity 127, etc.

In system maintenance 125, input dataset 101 (e.g., system logs, test cases, hardware status images, etc.) related to the system component 143 can be processed to answer user queries 128. The input dataset 101 can be processed to determine whether there are anomalies within the system that caused a detrimental effect to the system such as an outage. The user queries 128 can be relevant on how to properly maintain the system component 143 based on the input dataset 101 and deal with the detrimental effect to the system. A corrective action can be generated by the analytic server 106 which can include the answer to the user queries 128 (e.g., determining causes to bandwidth issues, etc.) to maintain the system component 143. Based on the corrective action (e.g., adding bandwidth, blocking packets from an identified internet protocol (IP) address to resolve malicious attacks, restarting hardware, etc.) the network system can be autonomously maintained.

Other downstream tasks and practical applications are contemplated.

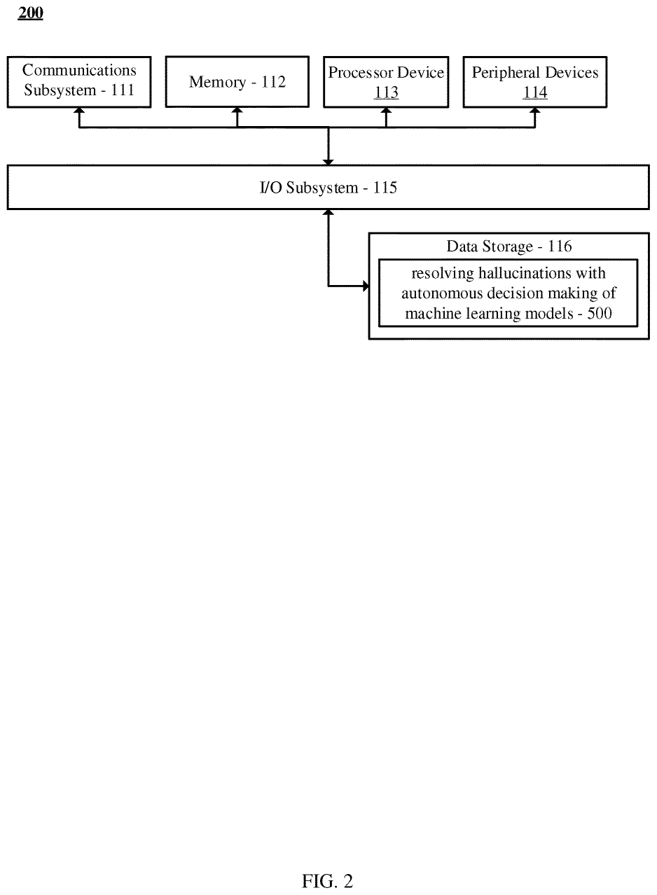

The analytic server 106 can include a processor device 113, a data storage device 116, a memory 112, a communications subsystem 111, peripheral devices 114, and an input/output (I/O) bus 115. The analytic server 106 is an implementation of a computer system. Other implementations are contemplated. The computer system is shown in more detail in FIG. 2.

Referring now to FIG. 2, a block diagram shows a computer system for resolving hallucinations with autonomous decision making of machine learning models, in accordance with an embodiment of the present invention.

The computing device 200 illustratively includes the processor device 113, an input/output (I/O) subsystem 190, a memory 112, a data storage device 116, and a communications subsystem 111, and/or other components and devices commonly found in a server or similar computing device. The computing device 200 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 112, or portions thereof, may be incorporated in the processor device 113 in some embodiments.

The processor device 113 may be embodied as any type of processor capable of performing the functions described herein. The processor device 113 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 112 may be embodied as any type of volatile or non-volatile memory or data storage capable of performing the functions described herein. In operation, the memory 112 may store various data and software employed during operation of the computing device 200, such as operating systems, applications, programs, libraries, and drivers. The memory 112 is communicatively coupled to the processor device 113 via the I/O subsystem 115, which may be embodied as circuitry and/or components to facilitate input/output operations with the processor device 113, the memory 112, and other components of the computing device 200. For example, the I/O subsystem 115 may be embodied as, or otherwise include, memory controller hubs, input/output control hubs, platform controller hubs, extracted control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 115 may form a portion of a system-on-a-chip (SOC) and be incorporated, along with the processor device 113, the memory 112, and other components of the computing device 200, on a single extracted circuit chip.

The data storage device 116 may be embodied as any type of device or devices configured for short-term or long-term storage of data such as, for example, memory devices and circuits, memory cards, hard disk drives, solid state drives, or other data storage devices. The data storage device 116 can store program code for resolving hallucinations with autonomous decision making of machine learning models 500. Any or all of these program code blocks may be included in a given computing system.

The communications subsystem 111 of the computing device 200 may be embodied as any network interface controller or other communication circuit, device, or collection thereof, capable of enabling communications between the computing device 200 and other remote devices over a network. The communications subsystem 111 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 200 may also include one or more peripheral devices 114. The peripheral devices 114 may include any number of additional input/output devices, interface devices, and/or other peripheral devices. For example, in some embodiments, the peripheral devices 114 may include a display, touch screen, graphics circuitry, keyboard, mouse, speaker system, microphone, network interface, and/or other input/output devices, interface devices, GPS, camera, and/or other peripheral devices.

Of course, the computing device 200 may also include other elements (not shown), as readily contemplated by one of skill in the art, as well as omit certain elements.

For example, various other sensors, input devices, and/or output devices can be included in the computing device 200, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 200 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

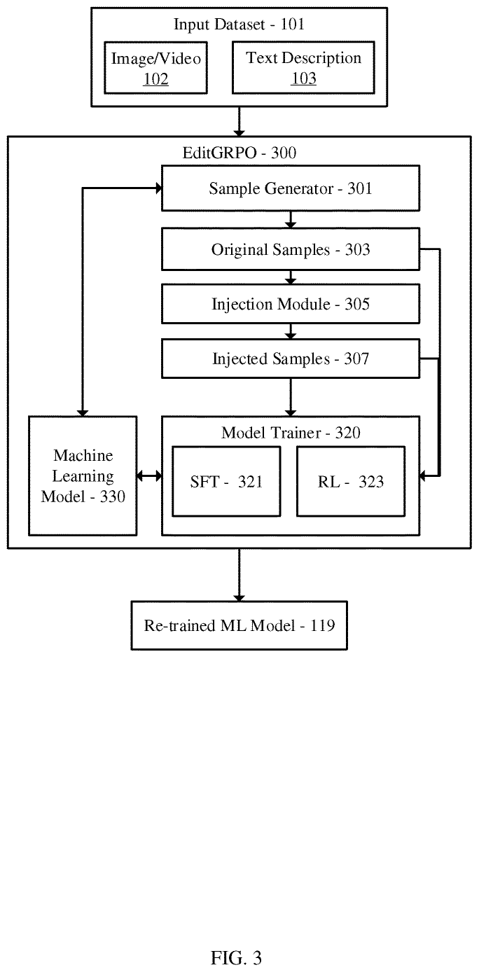

Referring now to FIG. 3, a block diagram shows components of a computer system for resolving hallucinations with autonomous decision making of machine learning models, in accordance with an embodiment of the present invention.

In an embodiment, image/video 102 and text description 103 can be processed by the editing GRPO module (EditGRPO) 300 to obtain a re-trained ML model 119. The EditGRPO 300 can include a sample generator 301, an injection module 305, and a model trainer 320.

The sample generator 301 that obtains original samples 303 from the image/video 102 and text description 103. The injection module 305 can process the original samples 303 and avoid mislabeling, false positives, and false negatives from the original samples 303, and obtain injected samples 307. The model trainer 320 can utilize supervised fine-tuning (SFT) 321 and reinforcement learning (RL) 323 to train the machine learning model (MLM) 330 and obtain the re-trained ML model 119. The MLM 330 can include visual language models, transformer-based models, artificial neural network based models, etc.

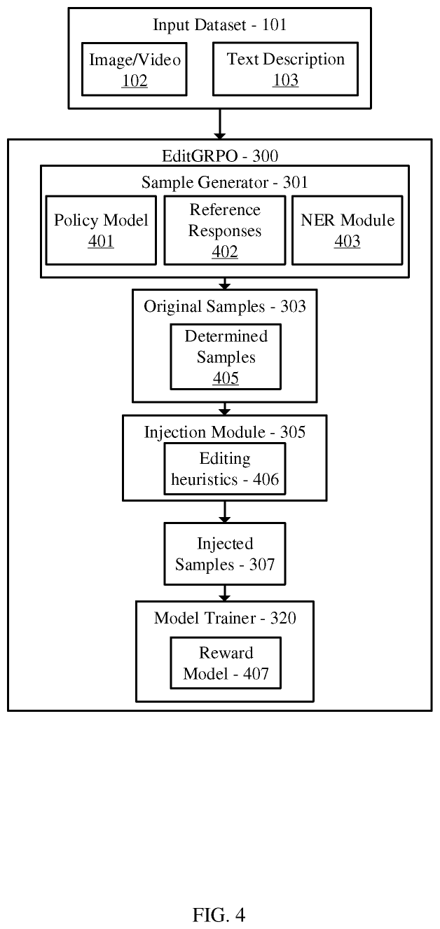

Referring now to FIG. 4, a block diagram shows subcomponents of a computer system for resolving hallucinations with autonomous decision making of machine learning models, in accordance with an embodiment of the present invention.

In an embodiment, the sample generator 301 can include a policy model 401 and a name entity recognition (NER) module 403 to obtain the original samples 303 from the machine learning model 330. The policy model 401 can provide heuristics based on reference responses 402 (e.g., responses known to have ground truth) to determine whether the original samples 303 are to be included in the determined samples 405. The policy model 401 also provides the policy that the MLM 330 utilizes to generate responses/outputs. The NER module 403 can classify the original samples based on the entity that it refers to. The original samples 303 can be classified into entities and further classified into determined samples 405. The injection module 305 can provide updates to the original samples 303 depending on the editing heuristics 406 determined for the original samples 303 and obtain the injected samples 307. The model trainer 320 can then utilize a reward model 407 to generate rewards for how the injection module 305 processed the determined samples 405.

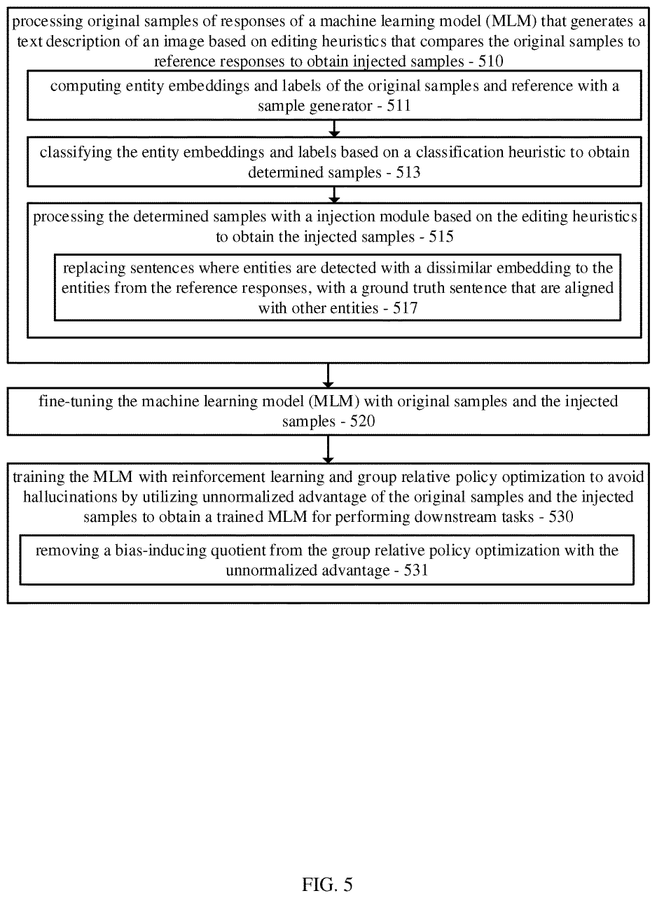

Referring now to FIG. 5, a flow diagram shows a high-level overview of resolving hallucinations with autonomous decision making of machine learning models, in accordance with an embodiment of the present invention.

In an embodiment, original samples of responses of a machine learning model (MLM) that generates a text description of an image can be processed based on editing heuristics that compares the original samples to reference responses to obtain injected samples. The machine learning model (MLM) can be fine-tuned with original samples and the injected samples. The MLM can be trained with reinforcement learning and group relative policy optimization to avoid hallucinations by utilizing an unnormalized advantage of the original samples and the injected samples to obtain a trained MLM for performing downstream tasks.

To further enhance clinical accuracy, some methods incorporate reinforcement learning (RL) to optimize for task-specific rewards, such as capturing “clinically relevant” features (e.g., features that are based on clinical reasoning) or maintaining logical consistency. Rule-based reinforcement learning techniques, exemplified by Group Relative Policy Optimization (GRPO), have shown strong potential for large-scale RL applications, particularly in tasks such as mathematical reasoning and code generation, and have recently been extended to multimodal setting. In the medical domain, GRPO has been explored in visual question answering tasks. However, GRPO has not yet been applied to medical field-specific image processing such as radiology report generation.

Training begins with a general-domain MLM with trainable parameters, following a two-stage approach: SFT followed by RL. This strategy allows the model to first adapt to the domain (e.g., healthcare data such as chest X-rays) and subsequently perform effective sampling during the RL phase.

In block 510, original samples of responses of a machine learning model (MLM) that generates a text description of an image can be processed based on editing heuristics to obtain injected samples.

In an embodiment, during training, the responses of a MLM 330 are edited by an injection module 305 to ensure that hallucinations, including false positives, false negatives, and mislabeled responses, are processed.

In block 511, entity embeddings and labels of the original samples and reference can be computed by a sample generator.

In an embodiment, the NER module 403 of the sample generator 301 can classify the original samples 303 based on the entity that it refers to. The sample generator 301 can then compute the entity embeddings and labels for classification. The NER module 403 can utilize a RaTE-NER module that can extract entities that describe observations such as “focal consolidation,” “metallic fragments,” or anatomies such as “cardiac” and “mediastinal” from the text descriptions 103.

In block 513, the entity embeddings and labels can be classified based on a classification heuristic.

In an embodiment, the policy model 401 can provide a classification heuristic to the MLM 330 to determine the type of mistake that is within the original samples 303 and obtain the determined samples 405. The types can include mislabeled entity, false-positives, false-negatives, etc.

In block 515, the determined samples can be processed by an injection module based on the editing heuristics to obtain the injected samples 307.

In an embodiment, given an original sample 303 (x) and a reference response 402 (y), the injection module 305 operates at the sentence level. For each sentence yⱼ of a reference response 402, let E(yⱼ) be the collection of all entities that occur in yⱼ, and let t be the cosine-similarity threshold. The editing heuristics 406 can include the following.

In block 517, sentences can be replaced where entities are detected with a dissimilar embedding to the entities from the reference response, with a ground truth sentence that is aligned with other entities. In an embodiment, the editing heuristics 406 can include determinations that if some sentence xᵢ contains a set of spurious entities e for all j at threshold t, and, compute:

$${s}^{*} = arg {max}_{j : {y}_{j} \neq {x}_{i}} \frac{1}{\vert {E}_{{f}_{p}} \vert} {\sum }_{e ∈ {E}_{{f}_{p}}} {max}_{{e}^{′} ∈ E [ {y}_{j} ]} cos ( e , {e}^{′} )$$

where e′ is an entity in the reference response 402 sentence yⱼ, τ is the cosine similarity threshold, and E_{f}_{ₚ} is the set of entities for a particular sentence with false positives, editing heuristics 406 can have instructions to replace xᵢ with Ys*

In an embodiment, the editing heuristics 406 can include determinations that if no replacement was made and there is still a sentence x with false-positive entities, then the editing heuristics 406 can have instructions to delete it.

In an embodiment, the editing heuristics 406 can include determinations that if there is an entity in y missing from x, editing heuristics 406 can have instructions to select one reference sentence y containing it and append y to the end of x.

In an embodiment, the editing heuristics 406 can include determinations that if none of the above applies, return x; if it is empty, replace it with any unused false-negative sentence yⱼ. A false negative sentence can be a sentence from the reference report that contained an observation entity that was not closely matched by any sentence in the generated report. For example, it could be “There is pneumothorax” if “pneumothorax” wasn't mentioned in any of the sentences of the generated report.

In block 520, the machine learning model (MLM) can be fine-tuned with original samples and the injected samples from a text description of an image

In an embodiment, the MLM 330 can be trained with supervised fine-tuning (SFT) 321 by the model trainer 320 for domain adaptation using cross-entropy loss until both the loss and clinical metrics stabilize. Formally, for each image set Xᵥ, a text prompt X_{q} (e.g., domain-specific images such as multi-view and longitudinal chest X-rays) containing clinical context information such as indication, technique, and comparison can be appended. The MLM 330 is then trained to predict the reference report tokens using its original autoregressive objective. Specifically, given a target findings section Xₐ of length L, the model is optimized to maximize the likelihood:

$${ℒ}_{SFT} ( θ ) = - {\sum }_{i = i}^{L} log {p}_{θ} ( {x}_{i} \vert {X}_{v} , {X}_{q < i} , {X}_{a < i} ) ,$$

where p are the responses and θ are trainable parameters of the MLM 330.

In block 530, the MLM can be trained with reinforcement learning and group relative policy optimization to avoid hallucinations by utilizing an unnormalized advantage of the original samples and the injected samples to obtain a trained MLM for performing downstream tasks.

Group relative policy optimization (GRPO) revealed that vanilla GRPO introduces optimization biases. For example, longer responses are penalized less due to their larger responses |oᵢ|, leading the policy to favor lengthier but potentially incorrect outputs. Additionally, a question-difficulty bias arises from the standard deviation term in the advantage function, where questions with low standard deviation (i.e., very easy or very hard, where rewards are mostly 1 or 0) are disproportionately weighted during policy updates.

In an embodiment, to overcome the limitations of SFT and improve clinical accuracy, reinforcement learning (RL) 323 presents a promising alternative to supervised fine-tuning (SFT). Unlike SFT 321, which is sensitive to specific phrasing, RL directly optimizes clinical efficacy metrics, allowing greater flexibility in expression and prioritizing essential clinical content. Previous studies have explored Proximal Policy Optimization (PPO) for report generation, but PPO suffers from low sample efficiency due to the need for a value function model.

In block 531, a bias-inducing quotient can be removed from the optimization process with the unnormalized advantage. In an embodiment, EditGRPO 300 utilizes unnormalized advantage A_{i,t}=R(q,oᵢ)—mean({R(q, o₁), . . . , R(q, o_{G})}), where responses oᵢ, i=1, . . . , G to a prompt q, for every token t.

By default, EditGRPO 300 samples g/2 response oᵢ, and fills the other half of the batch with edited versions o of these.

In an embodiment, to prevent model collapse, the checkpoint (e.g., saved model parameters) from the epoch prior to convergence with SFT 321 can be utilized as the starting point for RL 323 training.

In an embodiment, the optimization objective can be determined and is described below:

Let P (Q) denote the distribution over questions (images and prompts) used for training, where q is a sampled question in the current iteration. Let π_{θ}_{_{old}} and π_{θ}_{_{new}} denote the old policy and current (new) policy, respectively, where o is a complete response sampled from a policy. Let π_{θ}_{_{ref}} denote the reference policy, which in practice is the frozen base MLM. Let G be the number of responses sampled per question in each iteration. The GRPO objective is given by:

$${𝒥}_{GRPO} ( θ ) = {𝔼}_{q ∼ P ( Q ) , {\{ {o}_{i} \}}_{i = 1}^{G} ∼ {π}_{{θ}_{old}}} ( O \vert q )$$

$$[ \frac{1}{G} {\sum }_{i = 1}^{G} \frac{1}{\vert {o}_{i} \vert} {\sum }_{t = 1}^{\vert {o}_{i} \vert} ( min ( \frac{{π}_{{θ}_{new}} ( {O}_{i , t} \vert q )}{{π}_{{θ}_{old}} ( {O}_{i , t} \vert q )} {A}_{i , t} , clip ( \frac{{π}_{{θ}_{new}} ( {O}_{i , t} \vert q )}{{π}_{{θ}_{old}} ( {O}_{i , t} \vert q )} , 1 - ϵ , 1 + ϵ ) {A}_{i , t} ) ) - β {𝔻}_{KL} ( {π}_{{θ}_{new}} ‖ {π}_{{θ}_{ref}} ) ] , where {A}_{i , t} = \frac{R ( q , {o}_{i} ) - mean ( \{ R ( q , {o}_{1} ) , … , R ( q , {o}_{G} ) \} )}{std ( \{ R ( q , {o}_{1} ) , … , R ( q , {o}_{G} ) \} )}$$

In the reinforcement learning 323 setup, a rollout batch size of a predetermined size (e.g., 32) can be used. Image inputs are constrained to a predetermined size (e.g., maximum of 401,408 pixels and a minimum of 262,144 pixels). A stochastic gradient descent optimizer (e.g., AdamW) with a learning rate of 1.0 e-6 and a weight decay of 1.0 e-2 can be employed. During the rollout phase, the generation temperature is set to 1.0, and responses of a predetermined number can be sampled (e.g., five, ten, etc.) per prompt. To reduce memory usage, gradient checkpointing can be enabled and Fully Sharded Data Parallelism (FSDP) can be applied. Additionally, a memory efficient large language model such as vLLM can be used to accelerate inference and response generation.

In an embodiment, the model trainer 320 can apply reward signals without applying weighting which results in a composite reward. For example, the composite reward can include reward metrics such as RadGraph-F1, CheXbert, RaTE, etc. The reward signals can be generated by a reward function that is based on entity matching the positive or negative context of the entity determined within the original sample. The reward function can include balanced accuracies of predictions derived from an output by another model.

The training framework can be described as follows:
Training a multi-image vision language model M for X-ray report generation:
Input training set D
Train with supervised fine tuning until convergence:
For each example x of D:
Sample n generations of M for x
Compute entity embeddings and labels of samples and reference
Replace a sentence with a mislabeled sample entity, if any, or
Replace a sentence with a false positive entity, if any, or
Insert a sentence with a false negative entity
Compute unnormalized advantages with samples and edited samples
Use unnormalized advantages to compute GRPO loss
Backpropagate GRPO loss in M
If rewards are improved, continue another epoch
Output M with learned weights

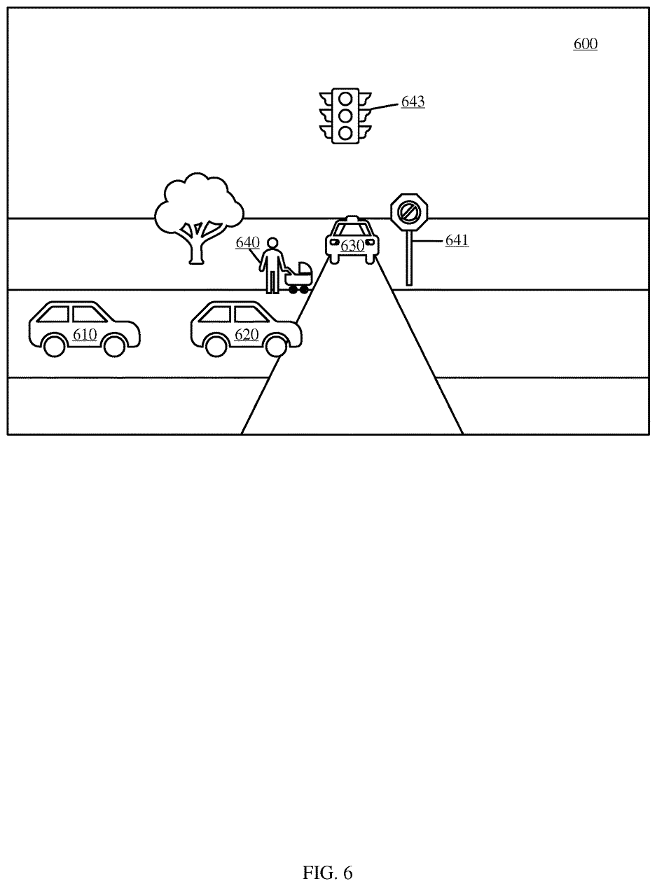

Referring now to FIG. 6, a block diagram shows an example of a practical application for resolving hallucinations with autonomous decision making of machine learning models, in accordance with an embodiment of the present invention.

In an embodiment, in traffic scene 600, vehicle 610 can communicate with analytic server 106 through a network. User queries 128 can be communicated to vehicle 610 through an artificial intelligence (AI) agent that can communicate with the analytic server 106. The user queries 128 can include commands to control vehicle 610 such as controlling the components of the vehicle (e.g., air quality control, entertainment components such as radio, etc.) and controlling the trajectory of the vehicle (e.g., speeding up, braking, changing direction, etc.) through autonomous decision making.

Vehicle 610 can autonomously understand the traffic scene 600 and generate traffic scene context based on the traffic scene by utilizing the re-trained ML model 119 that is trained to understand traffic scene contexts. For example, the traffic scene context generated can include incorrect summaries including “vehicle (620) is in the intersection as pedestrian (640) is crossing the intersection towards vehicle 620. Taxi (630) is moving towards a tree after colliding with vehicle 610 and 620.”

In an embodiment, the traffic scene context can be utilized by the model trainer 320 to train the trained machine learning model 118 and obtain re-trained ML model 119. In another embodiment, the trained machine learning model 118 can be trained continuously with the updated policy learned in real-time.

The traffic scene context can be utilized by the re-trained ML model 119 to generate processed predictions and trajectories for an autonomous vehicle 610. For example, the trajectories that avoid hallucinations from the real-world context of the traffic scene can include the following: “it is safe to cross the intersection and overtake vehicle (620) that is in the intersection as pedestrian (640) is crossing parallel to the intersection and taxi (630) is stopped behind one-way sign (641) as the light on (643) is red for taxi (630) and green for vehicle (620).”

In another embodiment, in traffic scene 600, vehicle 610 can simulate trajectories for the identified entities. In another embodiment, in traffic scene 600, based on the simulated trajectories of the identified entities, vehicle 610 can generate a trajectory to avoid the simulated trajectories of the identified entities and avoid collisions. In another embodiment, the vehicle 610 can be autonomously controlled based on the generated trajectory to avoid collisions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method, comprising:
processing original samples of responses of a machine learning model (MLM) that generates a text description of an image based on editing heuristics that compares the original samples to reference responses to obtain injected samples;
fine-tuning the machine learning model (MLM) with original samples and the injected samples; and
training the MLM with reinforcement learning and group relative policy optimization to avoid hallucinations by utilizing an unnormalized advantage of the original samples and the injected samples to obtain a trained MLM for performing downstream tasks.

2. The method of claim 1, wherein processing the original samples further includes computing entity embeddings and labels of the original samples and the reference responses with a sample generator.

3. The method of claim 2, wherein processing the original samples further includes classifying the entity embeddings and labels based on a classification heuristic to obtain determined samples.

4. The method of claim 3, wherein processing the original samples further includes processing the determined samples with an injection module based on the editing heuristics to obtain the injected samples.

5. The method of claim 1, wherein processing the original samples further includes replacing determined incorrect labels with correct labels based on the reference responses.

6. The method of claim 5, wherein processing the original samples further includes replacing sentences where entities are detected with a dissimilar embedding to the entities from the reference responses, with a ground truth sentence that are aligned with other entities.

7. The method of claim 1, wherein training the MLM further includes removing a bias-inducing quotient from the group relative policy optimization to compute unnormalized advantage.

8. The method of claim 1, wherein the downstream tasks further include processing generated summaries of a MLM regarding healthcare data by removing hallucinations from the generated summaries through autonomous decision making.

9. A system, comprising:
a memory device;
one or more processor devices operatively coupled with the memory device to perform operations including:
processing original samples of responses of a machine learning model (MLM) that generates a text description of an image based on editing heuristics that compares the original samples to reference responses to obtain injected samples;
fine-tuning the machine learning model (MLM) with original samples and the injected samples; and
training the MLM with reinforcement learning and group relative policy optimization to avoid hallucinations by utilizing an unnormalized advantage of the original samples and the injected samples to obtain a trained MLM for performing downstream tasks.

10. The system of claim 9, wherein processing the original samples further includes computing entity embeddings and labels of the original samples and the reference responses with a sample generator.

11. The system of claim 10, wherein processing the original samples further includes classifying the entity embeddings and labels based on a classification heuristic to obtain determined samples.

12. The system of claim 11, wherein processing the original samples further includes processing the determined samples with an injection module based on the editing heuristics to obtain the injected samples.

13. The system of claim 9, wherein processing the original samples further includes replacing determined incorrect labels with correct labels based on the reference responses.

14. The system of claim 13, wherein processing the original samples further includes replacing sentences where entities are detected with a dissimilar embedding to the entities from the reference responses, with a ground truth sentence that are aligned with other entities.

15. The system of claim 9, wherein training the MLM further includes removing a bias-inducing quotient from the group relative policy optimization to compute unnormalized advantage.

16. The system of claim 9, wherein the downstream tasks further includes processing generated summaries of a MLM regarding healthcare data by removing hallucinations from the generated summaries through autonomous decision making.

17. A non-transitory computer program product comprising a computer-readable storage medium including a program code, wherein the program code when executed on a computer causes the computer to perform operations including:
processing original samples of responses of a machine learning model (MLM) that generates a text description of an image based on editing heuristics that compares the original samples to reference responses to obtain injected samples;
fine-tuning the machine learning model (MLM) with original samples and the injected samples; and
training the MLM with reinforcement learning and group relative policy optimization to avoid hallucinations by utilizing an unnormalized advantage of the original samples and the injected samples to obtain a trained MLM for performing downstream tasks.

18. The non-transitory computer program product of claim 17, wherein processing the original samples further includes computing entity embeddings and labels of the original samples and the reference responses with a sample generator.

19. The non-transitory computer program product of claim 17, wherein training the MLM further includes removing a bias-inducing quotient from the group relative policy optimization to compute unnormalized advantage.

20. The non-transitory computer program product of claim 17, wherein the downstream tasks further includes processing generated summaries of a MLM regarding healthcare data by removing hallucinations from the generated summaries through autonomous decision making.
